(19) United States
(12) Patent Application Publication
(10) Pub. No.: US 2011/0097617 A1
(43) Pub. Date: Apr. 28, 2011

(54) Battery Set with Heat Conducting Jelly

(75) Inventors: Huan-Lung Gu, Hualien County (TW); Kou-Tzeng Lin, Hsinchu County (TW); Tseng-Te Wei, Hsinchu City (TW); Li-Ju Cheng, Hsinchu City (TW)

(73) Assignee: INDUSTRIAL TECHNOLOGY RESEARCH INSTITUTE, Hsin-Chu (TW)

(21) Appl. No.: 12/842,482

(22) Filed: Jul. 23, 2010

(30) Foreign Application Priority Data
Oct. 27, 2009 (TW) 098136305

(51) Int. Cl. H01M 10/50

(52) U.S. Cl. 429/120

(57) ABSTRACT

A battery set filled with heat conducting jelly is disclosed, which comprises a shell, for housing a cooling unit; and a plurality of battery cells, each battery cell being disposed inside the shell while having a heat conducting jelly, featuring with electric insulation and heat conduction abilities, to be filled surrounding the periphery thereof and contacting with the outer surface of each battery cell.

### TECHNICAL FIELD

The present disclosure relates to a battery set with heat conducting jelly, and more particularly, to a battery set having a plurality of batteries configured therein in a manner that the gaps between adjacent batteries are packed with heat conducting jelly, featuring with electric insulation and heat conduction abilities, while enabling each batteries to be cooled by an air-cooled or water-cooled cooling unit, by that not only the working temperatures of the batteries can be reduced rapidly, but also the temperature differences between the batteries can be eased off. In addition, since the batteries in the battery set are all being wrapped by the jelly capable of absorbing any vibration and noise for it is flexible, the battery set is a low-noise and shock resistance device.

### TECHNICAL BACKGROUND

It is noted that lithium batteries can be extremely dangerous if mistreated or if the metals containing therein is contaminated. They may ignited or explode if overheated or if charged to an excessively high voltage. Therefore, it can be very difficult to manufacture a large lithium battery of high voltage or high current, not to mention that it can also be very expensive. Conventionally, it is common to form a battery set by connecting a plurality of other types of batteries, such as nickel metal hydride cells or nickel-cadmium cells, in series or in parallel while packing the same inside a shell so as to be used as a large battery with high power output. Nevertheless, such large battery with high power output must be designed with a means for dissipating heat out of the package. For instance, one such design is by the use of its shell that is made of a metal with good heat conductivity for conducting heat out of the same; and another design is by the construction of air ducts inside the package for improving the air convention inside out the package. It is noted that the more batteries being packed inside a shell for forming one battery set, the more dangerous the battery set will be. It is known that the most common 144V, 40 Ah battery set for modern electric vehicles is composed of six 48V battery modules in series connection whereas each 48V battery module further is the composition of thirteen 3.7V, 20 Ah large battery cells in series connection. Accordingly, the core temperature of such battery set for electric vehicles can easily reach a dangerous temperature of 200° C. if its heat dissipating ability is not sufficient. In addition no matter the heat dissipation structure built in such battery set is an air-cooled cooling structure or a water-cooled cooling structure, there is usually a thin layer of static air cushioning formed between its battery cells and the heat dissipating medium of the cooling structure which can severely hampered the heat dissipating ability of those battery cells since the air cushion is going to act as an isolation layer with poor heat transfer coefficient. Thus, if the layer of static air is replaced by some other medium with higher heat transfer coefficient, the heat dissipating ability can be enhanced.

Generally, fans are required in most common air-cooled battery sets for forcing air convection so as to take heat away from the battery sets. However, since there is usually a limited space in many electric systems that is available for the disposition of the battery set, such as the compact-sized electric vehicles, there can be a very small interval allowed to be existed between any adjacent battery cells in the battery set as the volume of the battery set must be adapted for fitting the same into the limited space. Consequently, the paths formed inside the battery set that are provided for the cooling air the flow therein can be very small and thus will cause the flowing air to suffer by a very large wind resistance, by that not only vortexes can be formed between the battery cells, but also hot air in the battery set to be hold stationary between battery cells without being expelled. Please refer to FIG. 1 and FIG. 2, which show a conventional air-cooled battery set. In FIG. 1 and FIG. 2, the battery set 10 is comprised of a plurality of battery cells 12 that are sandwiched between a plate-like cover 111 and a plate-like base 112, whereas the cover 111 and base 112 are fixedly coupled with each other by screw bolts 16 so as to construct a shell 11. From the portion of the cover 111 that is cut open and exposed, as shown in FIG. 1, it is obvious that each battery cell 12 in the battery set 10 is configured with electrodes 121 that are arranged extruding out from the top surface of the cover 111 and are connected with each other either in series connection or in parallel connection by the use of connecting plates 13 that are also disposed on the top surface of cover 111. In addition, for dissipating heat out of the battery set 10, not only the battery set 10 is configured with an air-cooled cooling unit for blowing cooling air 14 to its battery cells 12, but also the base 112 is constructed with a plurality of heat dissipating fins 133 for enhancing heat dissipation. Since the battery cells 12 are disposed separating from each other by a specific interval, there can be vortexes 15 formed therebetween which will obstruct the flowing of the cooling air 14. However, if a high-power fan is used for causing an intense flow of cooling air 14, there will be more heat being dissipated from those battery cells 12 located near the inlet of the cooling air 14 than those located near the outlet of the cooling air 14 which not only is going to increase the temperature differences between the battery cells, but also will cause power loss to increase. Moreover, as the temperature differences between battery cells are increased, the size differences between battery cells are increased by the effect of thermal expansion which not only will shorten the lifespan of those battery cells, but also will cause the insulting shell for packing the battery cells to expand or contract with respect to those size variations caused by the different thermal expansions and result in the fasteners of the shell to become loosen.

For those water-cooled battery sets with better heat dissipating efficiency than those air-cooled battery sets, there are water channels being established inside the shell thereof that are provided for the cooling water to circulate therein as it is being pumped by a built-in water pump and thus bring the heated cooling water away from the battery cells to a heat sink for heat dissipation. Although the heat dissipating efficiency is improved comparing with the air-cooled battery sets, there is inevitably a gaps formed between its battery cells and the shell that can severely hampered the heat dissipating ability. Consequently, a larger water pump capable of a larger amount of cooling water to circulate is used for overcoming the aforesaid shortcoming, but at a cost of higher manufacture cost.

Accordingly, both of the two types of battery sets, i.e. the water-cooled battery set and the air-cooled battery set, have their own disadvantages with respect to heat dissipation which can severely restrict the their applications and also shorten their lifespan.

There are already many studies for overcoming the aforesaid problems. One of which is a rechargeable lithium battery disclosed in TW Pat. Pub. No. 1283493, in which a conductive gel polymer is filled in a space between the anode plate and the cathode plate inside a lithium battery to be used as a solid-electrolyte for enabling the discharging and recharging of the lithium battery.

Another such study is a secondary lithium battery disclosed in U.S. Pat. No. 6,716,552, entitled “Second Lithium Battery Construction for Improved Heat Transfer”. The battery shown in U.S. Pat. No. 6,716,552 includes: a negative electrode; a positive electrode a separator sandwiched between the electrodes; an electrolyte impregnating the separator and being in a fluid communication with the electrodes; and a metal package adapted for containing the electrodes, the separator, and the electrolyte. By the impregnation of the electrolyte, not only the reaction concentration is enabled to be distributed evenly in the battery, but also the heat caused by the reaction can be transfer to the metal package where it is further being dissipated into air, so that the temperature of each battery cells in the battery can be reduced for preventing the same form rupturing.

Moreover, in CN Pat. No. 101432906, a separator with a layer of gel polymer for batteries is disclosed, which is substantially a porous gel-like separation layer, being impregnated with electrolyte and sandwiched between the anode and cathode of a cell, that is used for enhancing the power quality of the battery.

It is noted that all the means for improving heat dissipation disclosed in the above prior arts are constructed inside the battery cells of a battery set, and there is no heat dissipation means that is constructed outside the battery cells.

### TECHNICAL SUMMARY

The present disclosure provides a battery set having a plurality of battery cells configured therein in a manner that the gaps between adjacent battery cells are packed with heat conducting jelly, featuring with electric insulation and heat conduction abilities, while enabling each battery cells to be cooled by an air-cooled or water-cooled cooling unit, by that not only the working temperatures of the battery cells can be reduced rapidly, but also the temperature differences between the battery cells can be eased off. In addition, since the battery cells in the battery set are all being wrapped by the jelly capable of absorbing any vibration and noise for it is flexible, the battery set is a low-noise and shock resistance device.

To achieve the above object, the present disclosure provides a battery set with heat conducting jelly, comprising: a shell, for housing a cooling unit; and a plurality of battery cells, each battery cell being disposed inside the shell while having a heat conducting jelly, featuring with electric insulation and heat conduction abilities, to be filled surrounding the periphery thereof and contacting with the outer surface of each battery cell.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a three dimensional view of a conventional air-cooled battery set.

FIG. 2 is an A-A cross-sectional view of FIG. 1.

FIG. 3 is a three dimensional view of a battery set according to a first embodiment of the present disclosure.

FIG. 4 is a B-B cross-sectional view of FIG. 3.

FIG. 5 and FIG. 6 are schematic diagrams showing a method for manufacturing a battery set of the present disclosure.

FIG. 7 is a three dimensional view of a battery set according to a second embodiment of the present disclosure.

FIG. 8 is an exploded view of FIG. 7.

FIG. 9 is a C-C cross-sectional view of FIG. 7.

FIG. 10 is a cross-section view of a battery set according to a third embodiment of the present disclosure.

FIG. 11 is a chart depicting the variation of temperature relating to two different rows of batteries that are arranged inside a conventional water-cooled battery set without the disposition of the heat conducting jelly of the present disclosure.

FIG. 12 is a chart depicting the variation of temperature relating to two different rows of batteries that are arranged inside a water-cooled battery set with the disposition of the heat conducting jelly of the present disclosure

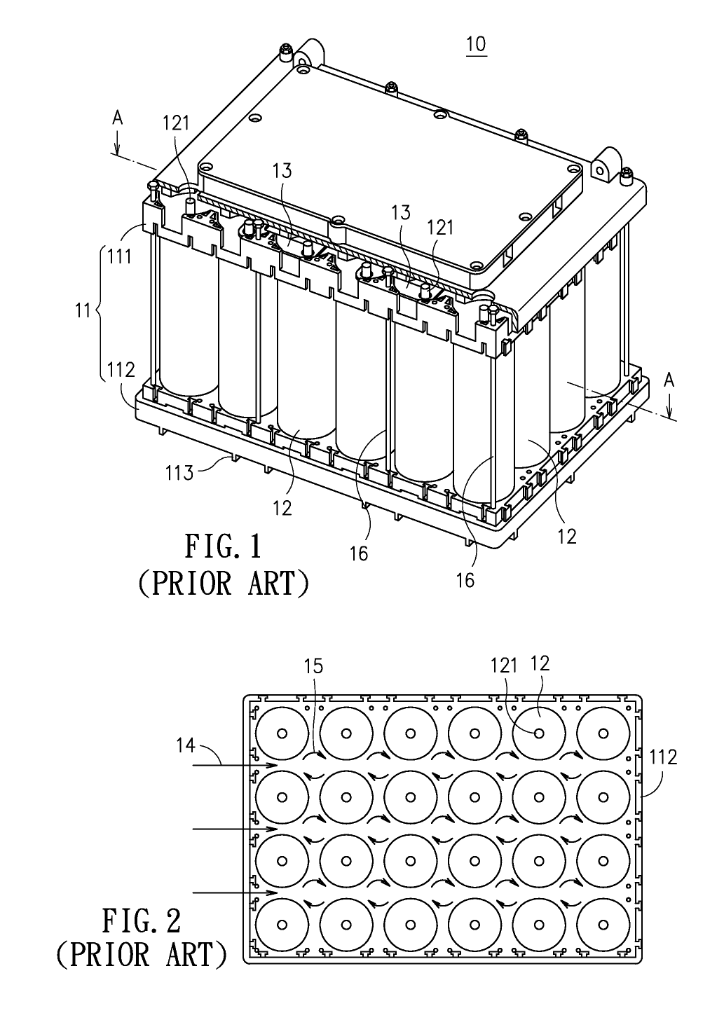

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

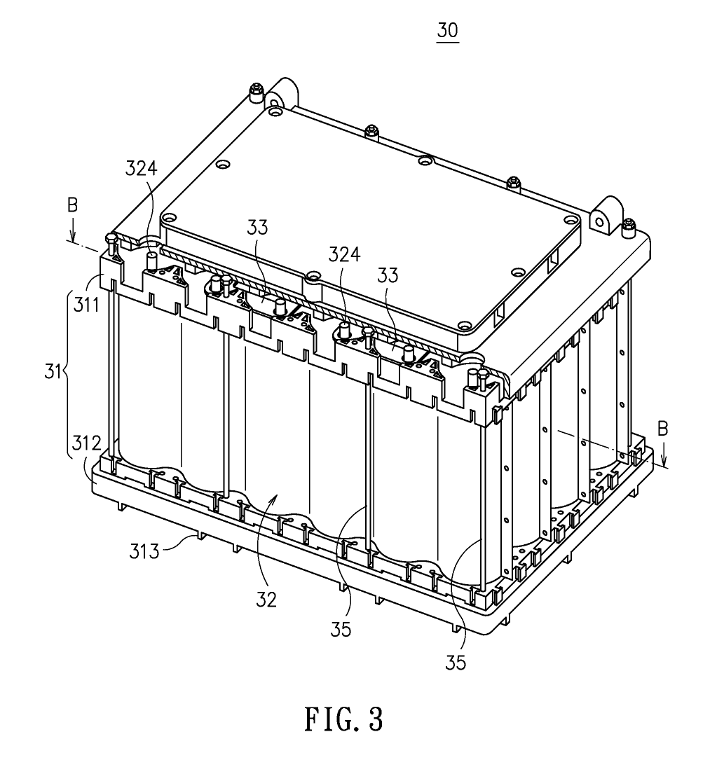

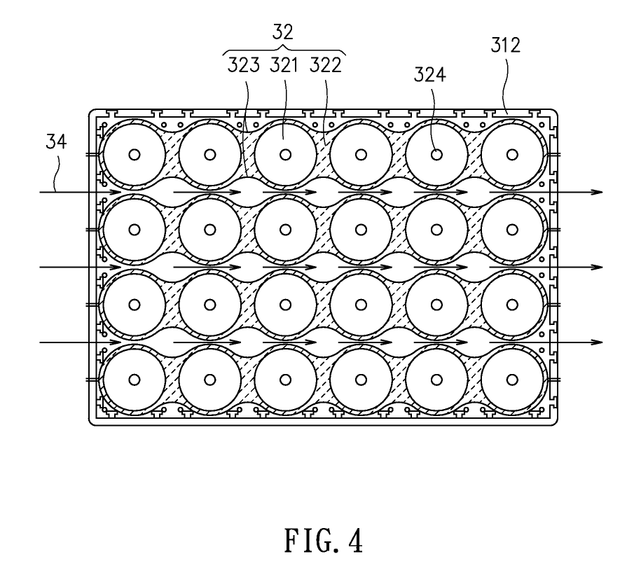

Please refer to FIG. 3 and FIG. 4, which show a battery set according to a first embodiment of the present disclosure. In the first embodiment shown in FIG. 3 and FIG. 4, the battery set 30 is comprised of a plurality of battery units 32 that are sandwiched between a plate-like cover 311 and a plate-like base 312, whereas the cover 311 and base 312 are coupled with each other by screw bolts 35. From the portion of the cover 311 that is cut open and exposed, as shown in FIG. 3, it is obvious that each battery unit 32 in the battery set 30 is configured with electrodes 324 that are arranged extruding out from the top surface of the cover 311 and are connected with each other either in series connection or in parallel connection by the use of connecting plates 33 that are also disposed on the top surface of cover 311. In addition, for dissipating heat out of the battery set 30, not only the battery set 30 is configured with an air-cooled cooling unit for blowing cooling air 34 to its battery cells 2, but also the base 12 is constructed with a plurality of heat dissipating fins 313 for enhancing heat dissipation.

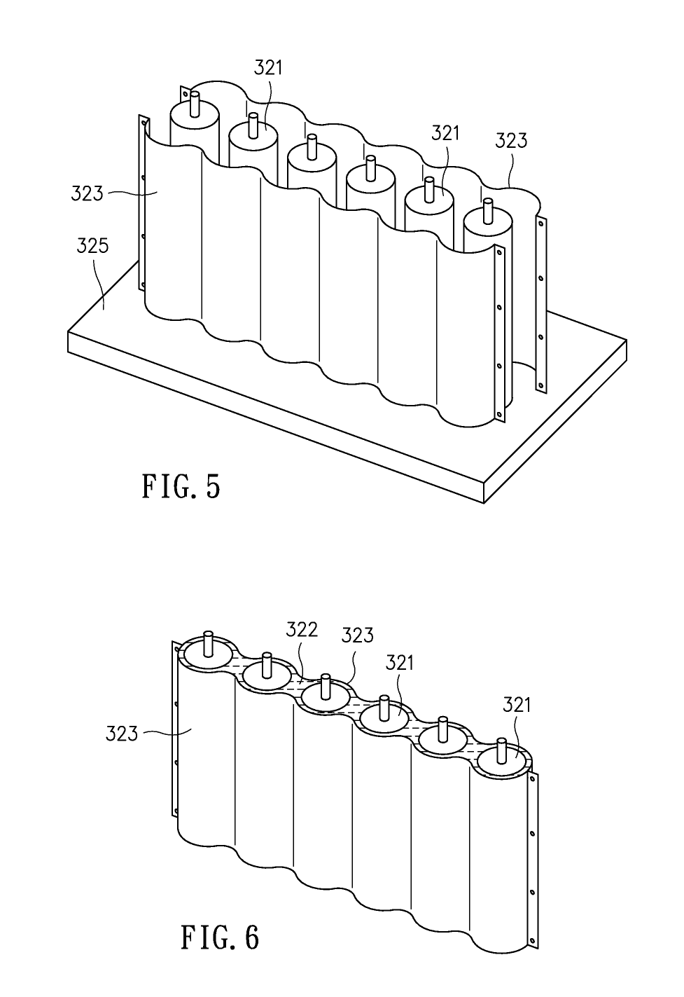

As shown in FIG. 4 to FIG. 6, the battery unit 32 is composed of a battery cell 321, a heat conducting jelly 322 and a heat conducting structures 323, in which each individual battery cell 321 can be any cell that is available, but in this embodiment, the lithium battery that is featuring by its high heat emission is used so as to demonstrate the cooling power of the present disclosure. Moreover, the heat conducting jelly 322 is primarily made up of a silicon with insulation and fire resistance abilities, whereas the silicon is further doped with other insulation materials of good heat conduction ability, such as aluminum nitride, and thus the heat conducting jelly 322 can be the TSE3941—Flame Retardant Silicon Adhesive Sealant, produced by Momentive Performance Materials Japan LLC. The reason why silicon is used as the heat conducting jelly 322 in this embodiment is that: it is easy to adhere on any metal, but still is not too sticky for creating trouble while it is needed to dismantle the battery set 30, or while a certain battery units 32 in the battery set 30 are required to be maintained or replaced. In addition, the silicon will not cause any shortage even when it is being accidentally adhered upon the electrodes 324 since it is electrically insulated. As shown in FIG. 4, the heat conducting structure 323 is composed of two wave-plates made of a material of high thermal conductivity. Structurally, as shown in FIG. 5, there are six battery cells 321 of the same row in the batter set 30 being lined up and positioned on a positioning tool 325 while arranging the heat conducting structure 323 of two wave-plates symmetrically at the two sides of the row in respective for sandwiching the row of battery cells 321 therebetween. It is noted that the two wave-plates of the heat conducting structure 323 can first be coupled with each other by screwing or riveting before the row of battery cells 321 can be placed inside the confinement of the heat conducting structure 323, and then the coupled heat conducting structure 323 are fixed onto the positioning tool 325 while maintaining a gap to be formed between each wave-plate of the heat conducting structure 323 and its corresponding battery cells 321. Since the heat conducting jelly 322 is made of a silicon which is a liquid-like material that can turn into a solid plastic of good elasticity and flame retardant ability after contacting with air and moisture for a specific period of time, the liquid-like jelly 322 can be poured to fill all the gaps formed between the heat conducting structure 323 and the battery cells 321 and those formed between adjacent battery cells 321 in a manner that each battery cell 321 is completely surrounded and wrapped by the jelly 322, and thus, after the jelly 322 is solidified either naturally or by the help of curing agent, a row of six battery units 32, each comprising a battery cell 321, a heat conducting jelly 322 and a heat conducting structure 323, can be achieved after the two is detached from the positioning tool 325, as the one shown in FIG. 6. Thereafter, by placing a plurality of such rows of battery units 32 inside the shell 31 of FIG. 3, a battery set 30 is completed. It is noted that the filling of the heat conducting jelly 322 should guarantee that all the gaps formed between the battery cells 321 and the heat conducting structure 323 and those formed between adjacent battery cells 321 are filled in a manner that the periphery of each battery cell 321 is completely surrounded and wrapped by the heat conducting jelly 322.

As shown in FIG. 6, since each battery cell 321 is wrapped by the heat conducting jelly 322 which is featured with electric insulation and heat conduction abilities, the heat generated from the battery cells 321 will be transferred rapidly to the heat conducting structure 323 through the heat conducting jelly 322, where it is further being transferred out of the battery set 30 by the blowing of the cooling air 34. It is noted that, by the disposition of the heat conducting structure 323, there will be wind tunnels being formed between battery units for enabling the cooling air to blow smoothly therethrough. Therefore, there will be no vortexes being formed in the battery set 30 so that any heat emitted from the battery cells can be transferred to the outside world smoothly and rapidly.

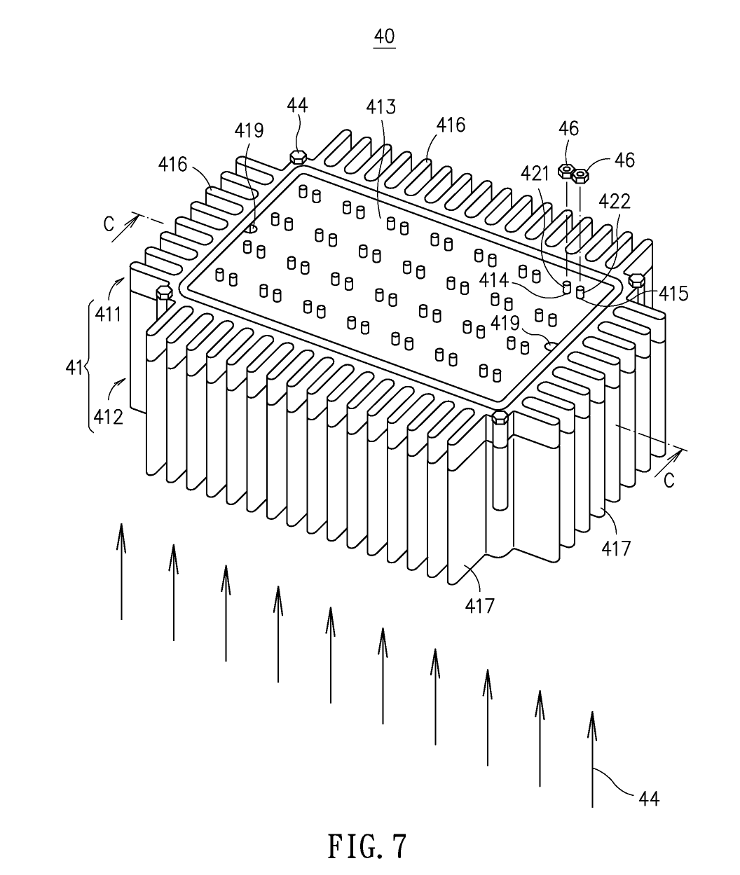

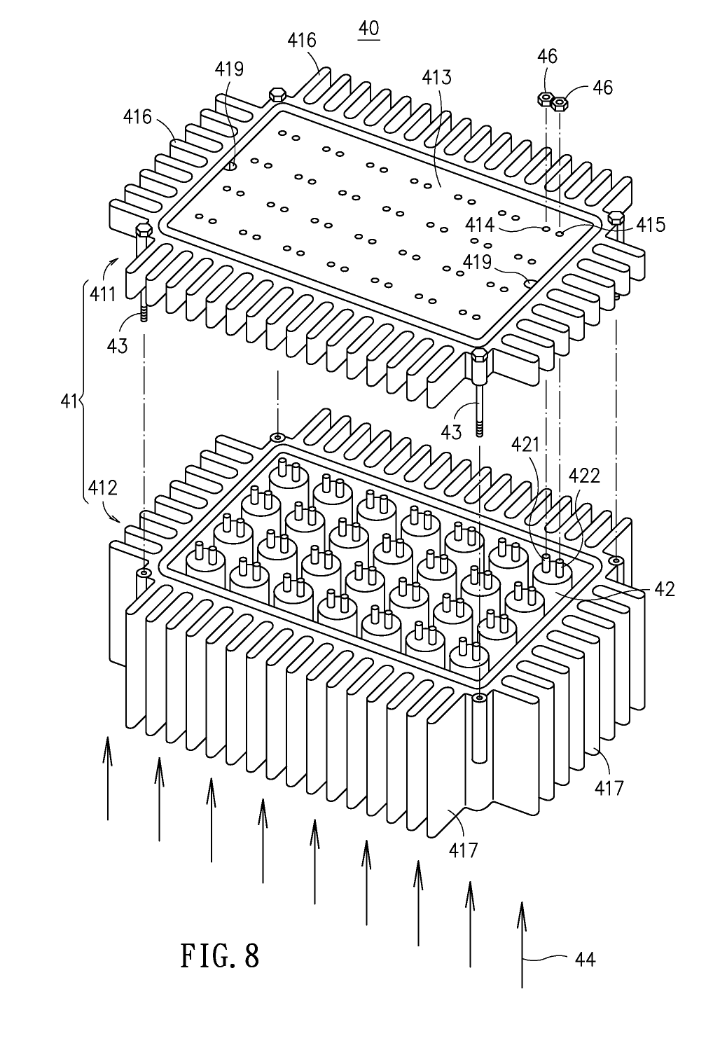

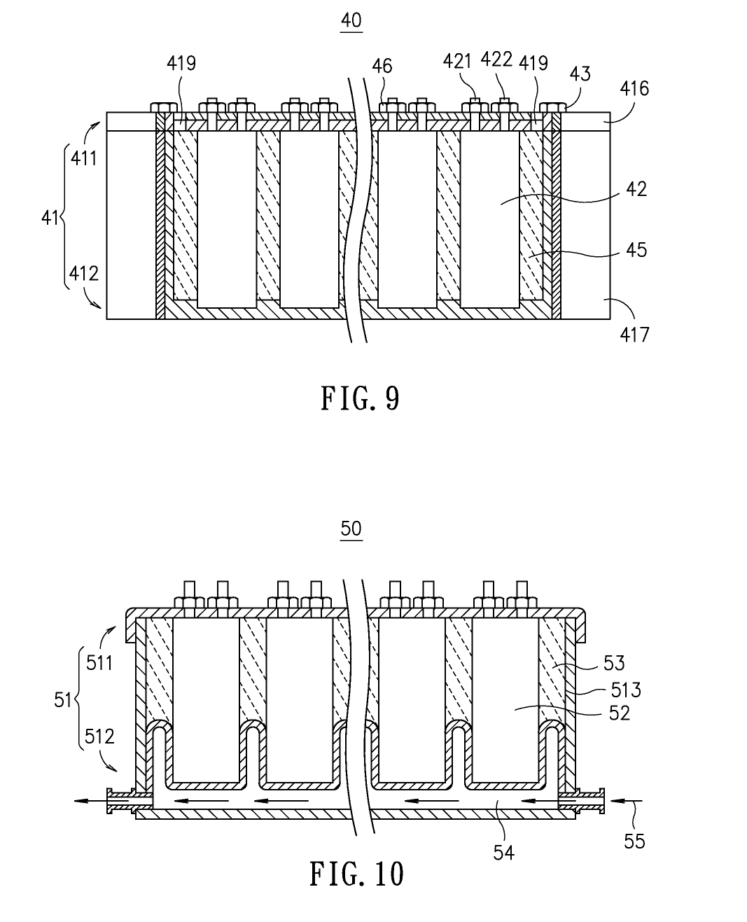

Please refer to FIG. 7 to FIG. 9, which show a battery set according to a second embodiment of the present disclosure. In this second embodiment, the battery set 40 is comprised of a plurality of battery units 42 that are sandwiched between a plate-like cover 411 and a plate-like base 412, whereas each battery unit 32 has a cathode electrode 421 and an anode electrode 422 fitted on top thereof while enabling an insulation plate 413 mounted on the cover 411 to be formed with holes 414 at positions corresponding to the cathode and anode electrodes 421, 422 of each battery unit 32 in a manner that the electrodes 421, 422 is able to extrude out from the top surface of the insulation plate 413. Moreover, by the disposition of the connecting plate at the top of the insulation plate 413, the electrodes 421, 422 can be connected with each other in serial connection or in parallel connection by the use of screw nuts 46. In addition, there is a plurality of heat dissipating fins 416, 417 being arranged surrounding the outer circumferences of the cover 411 and the base 412, whereas the cover 411 and base 412 are coupled with each other by screw bolts 43. Similarly, for dissipating heat out of the battery set 40, the battery set 30 is configured with an air-cooled cooling unit for blowing cooling air 44 to its battery cells 2, whereas the cooling air 44 is guided to blow in a direction parallel with the heat dissipating fins. The difference between the second embodiment and the first embodiment shown in FIG. 3 is that: the base 412 is formed in a shape like a box having an accommodation space 418 that is provided for the battery cells 42 to be received therein; and there are two through holes 419 formed on the cover 411 symmetrically at the two sides thereof while enabling the two to be in communication with the accommodation space 418 of the base 412 when the cover 411 is integrated with the base 412 by screwing. By the disposition of the through holes 419, the heat conducting jelly 45 in liquid state can be poured into the accommodation space 418 while enabling the same to fill all the gaps formed between the battery units 42 and the base 412 and those formed between adjacent battery units 42. After the jelly 45 is cured, each battery unit 42 is being substantially fixed inside a mass of elastic solid heat conducting jelly 45 while allowing no air gap to be existed between the battery units 42 and the shell 41. Thus, the heat transfer efficiency at the boundaries thereof can be very high, so that any heat emitted from the battery units 42 can be transferred to shell 41 rapidly through the heat conducting jelly 45, at which, by the help of the heat dissipating fins 416, 417 and the blowing cooling air 44, the heat can be transferred to the outside world smoothly and rapidly.

Please refer to FIG. 10, which is a cross-section view of a battery set according to a third embodiment of the present disclosure. In this third embodiment, the battery set 50 is comprised of: a shell 51 composed of a cover 511 and a base configured with an accommodation space 513; and a plurality of battery units 42, being received inside the accommodation space 513. The present embodiment is characterized in that: the battery set 50 is configured with a water-cooled cooling unit, and correspondingly, there is a water channel 54 formed at the bottom of the base 512 that is provided for the cooling water 55 of the water-cooled cooling unit to flow therethrough. Thereby, any heat from the working battery units 52, that is transferred to the shell 51 through the heat conducting jelly 53, can be dissipated rapidly by the flowing of the cooing water 55.

It is noted that the aforesaid embodiments for transferring heat by the use of heat conducting jelly may be varied in many ways. Such variations can be adapted for various types of battery units and shapes of shells as well, not to mentioned that they are suitable for any air-cooled or water-cooled cooling units, so that such variations are not to be regarded as a departure from the spirit and scope of the disclosure.

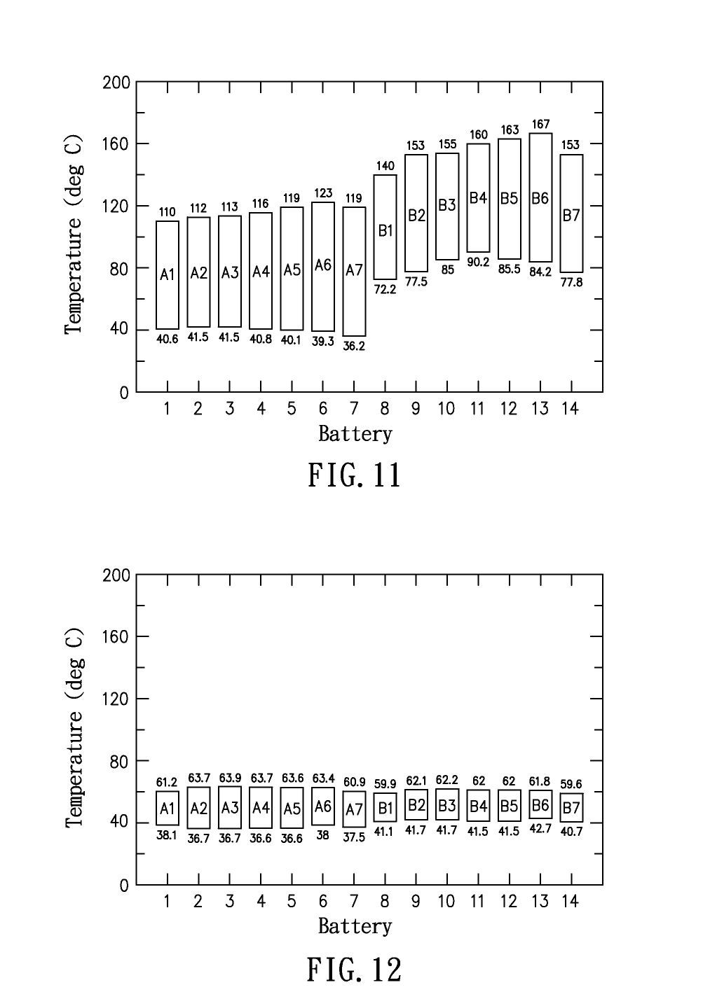

FIG. 11 is a chart depicting the variation of temperature relating to two different rows of batteries, i.e. the first row of battery units A1˜A7 and the second row of battery units B1˜B7, that are arranged inside a conventional water-cooled battery set without the disposition of the heat conducting jelly of the present disclosure. FIG. 12 is a chart depicting the variation of temperature relating to the two different rows of batteries that are arranged inside a water-cooled battery set with the disposition of the heat conducting jelly of the present disclosure. It is noted that when there is heat conducting jelly being disposed inside the battery set as those depicted in the present disclosure, the temperature differences between battery units are reduced significantly. Taking the battery unit A1 for instance, its temperature may vary in a ranged between 40.6° C. and 110° C. when there is no heat conducting jelly and is dependent solely upon the water-cooled cooling unit for heat dissipation, nevertheless, when there is heat conducting jelly in the battery set for cooperating with the water-cooled cooling unit, its temperature variation is reduced and varies in a range between 38.1° C. and 61.2° C. It is noted that although the battery set with heat conducting jelly can adapted for cooperating with either air-cooled cooling unit or water-cooled cooling unit, it is better working with water-cooled cooling unit for achieving optimal cooling effect. Especially for those battery sets which had already equipped water-cooled cooling units with good cooling efficiency, its cooling power can be further improved while enabling its temperature variation to be reduced if it is further configured with the heat conducting jelly of the present disclosure.

To sum up, the present disclosure provides a battery set having a plurality of batteries configured therein in a manner that the gaps between adjacent battery cells are packed with heat conducting jelly, featuring with electric insulation and heat conduction abilities, while enabling each battery cells to be cooled by an air-cooled or water-cooled cooling unit, by that not only the working temperatures of the battery cells can be reduced rapidly, but also the temperature differences between the battery cells can be eased off. In addition, since the battery cells in the battery set are all being wrapped by the jelly capable of absorbing any vibration and noise for it is flexible, the battery set is a low-noise and shock resistance device.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A battery set with heat conducting jelly, comprising:
a shell, for housing a cooling unit; and
a plurality of battery cells, each of the battery cells disposed inside the shell while having a heat conducting jelly, featuring with electric insulation and heat conduction abilities, to be filled surrounding the periphery thereof and contacting with the outer surface of each of the battery cells.

2. The battery set of claim 1, wherein the jelly is filled for covering almost the complete outer surface of each of the battery cells.

3. The battery set of claim 1, wherein the jelly is substantially a silicon containing heat conducting materials.

4. The battery set of claim 1, wherein the heat transfer coefficient of the jelly is higher than that of the air.

5. The battery set of claim 1, further comprising:
at least one heat conducting structure, being arranged at a position corresponding to the periphery of at least one battery cell of the plural battery cells while separating from the corresponding battery cells by a gap of a specific distance as the gap is filled with the jelly.

6. The battery set of claim 5, wherein each heat conducting structure is a plate of high thermal conductivity.

7. The battery set of claim 1, wherein the shell is composed of a cover and a base.

8. The battery set of claim 7, wherein both the cover and the base constructed as flat plate-like structures provided for sandwiching the plural battery cells therebetween.

9. The battery set of claim 7, wherein the base is configured with an accommodation space for receiving the plural battery cells therein.

10. The battery set of claim 9, wherein the cover is configured with at least one through hole while enabling each through hole to be in communication with the accommodation space of the base.

11. The battery set of claim 9, wherein the at least one through hole is provided for pouring the jelly in an non-solid state into the accommodation space while enabling the same to fill all the gaps formed between the battery cells and the base and those formed between adjacent battery cells in a manner that each battery cell is completely surrounded and wrapped by the jelly.

12. The battery set of claim 1, wherein the shell is further comprised of a plurality of heat dissipating fins.

13. The battery set of claim 1, wherein each battery cell is a type of lithium cell.

14. The battery set of claim 1, wherein the cooling unit is an air-cooled cooling device configured with at least one fan that is provided for generating cooling air while enabling the same to be blow toward the battery cells wrapped inside the jelly.

15. The battery set of claim 1, wherein the cooling unit is a water-cooled cooling device, and correspondingly, the shell is further formed with a water channel that is provided for cooling water of the water-cooled cooling device to flow therethrough.
